(19) United States
(12) Patent Application Publication
(10) Pub. No.: US 2011/0258813 A1
(43) Pub. Date: Oct. 27, 2011

(54) Paper clip

(76) Inventor: Kai Chen Lu, San Jose, CA (US)

(21) Appl. No.: 12/662,593

(22) Filed: Apr. 26, 2010

(51) Int. Cl. B42F 1/04

(52) U.S. Cl. 24/67.9

(57) ABSTRACT

A novel and improved paper clip is formed from a single length of resilient metal wire bent into a configuration, having additional series of re-entrant loops. The upper loops are closely grouped together reducing the length of the arms, which allow stronger gripping force to be concentrated on the clamping jaws. The lower loops interconnecting the length-reduced arms form additional number of clamping jaws, which significantly add further holding strength. These particular features result in practical advantages in that the paper clip of the present invention provides a firm gripping force to effectively hold sheets of paper together without slipping or shifting; and does not create a large bulk in one area to make the pile unmanageable due to its flat form, and does not waste space in drawers and boxes as the upper loops are closely grouped together, and is simple and inexpensive to manufacture.

### BACKGROUND OF THE INVENTION

The conventional “Gem” paper clip is commonly used and made of an iron wire through bending process, for fastening sheets of paper together. One disadvantage of this kind of paper clip is its weak clamping force causing the sheets of paper to slip away easily from the paper clip when the papers are clipped together.

Other types of clips, such as bulldog clips or banker's clasps, are very much thicker than the stack of paper creating a large bulk in one area and waste space in drawers and boxes.

The present invention is using a single paper clip to secure together sheets of paper, which made by bending a single length of resilient metal wire into shape, constructing additional number of upper portion loops, lower portion loops, clamping arms, and two smoothly rounded free ends of the wire, laying flat and all nesting in a common plane.

The upper portion loops are closely grouped together reducing the length of the clamping arms, the length of which being defined between the upper portion loops and the lower portions loops. This provides the advantages of distributing and moving the gripping force from their upper distal ends to the lower portion of the clamping arms, the gripping force is urged toward the clamping jaws. The lower portion is made in the configuration of additional number of loops connected with the length-reduced arms acting as additional cooperating clamping jaws. These features greatly increase gripping force of the paper clip for effectively holding sheets of paper together.

When fastened to sheets of paper, the additional cooperating clamping jaws on each side of the paper create stronger tensile elasticity and remain closely attached to the opposite sides of the paper. The sheets of paper are interlocked between clamping jaws and it would take a pull sufficient to flex the paper, therefore the paper clip does not become dislodged from the paper.

### SUMMARY OF THE INVENTION

The object of the present invention is to provide a new and improved paper clip of the character described which provides improved gripping pressure for tightly holding sheets of paper together more effective in a novel and simple manner.

Another object of the present invention is to provide a new and improved paper clip of the character described which remains its flat form when stacking clipped papers and material on top of each other in piles, does not create a large bulk in one area to make the pile unmanageable and wastes space in drawers and boxes.

Another object of the present invention is to provide a new and improved paper clip of the character described which the upper loops are closely grouped together; therefore they do not stick out and wastes space in drawers and boxes.

A further object of the present invention is to provide a new and improved paper clip of the character described which the smoothly rounded ends A and B of the wire eliminate the possibility of ends digging in, and mutilating or damaging the papers as the paper clip is applied and removed.

Yet, a further object of the present invention is to provide a new and improved resilient paper clip of the character described which is simple and inexpensive to manufacture.

### BRIEF DESCRIPTION OF THE DRAWINGS

The foregoing and other objects, features, and advantages of the present invention will be best understood from the following description, the appended claims and the accompanying drawings in which:

FIG. 1 is a front view of the paper clip according to the present invention;

FIG. 2 is a side view of FIG. 1;

FIGS. 3 through 12 are each front and side views of paper clips, with configuration variations from the preferred embodiment of FIG. 1 which have satisfactory paper clipping characteristics of the present invention of FIG. 1.

### DETAILED DESCRIPTION OF THE PREFERRED EMBODIMENTS

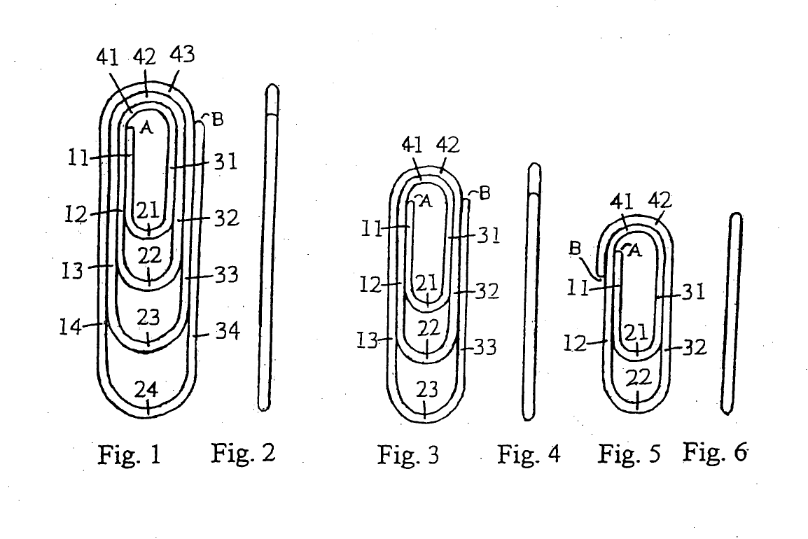

FIG. 1 is a front view of a paper clip manufactured in accordance with the present invention composed of a single, continuous length of resilient metal wire multiply bent re-entrantly to define a plurality of loops formed to comprise a first arm 11 of the wire continuing in a first direction from rounded end A of the wire a first distance. A first re-entrant loop 21 of the wire continues from that first arm 11 into a second arm 31 a second distance in a second direction opposite the first direction. A second re-entrant loop 41 of the wire continues from the second arm 31 and into a third arm 12 continuing from a second loop 41 a third distance but in the first direction. A third re-entrant loop 22, spaced from loop 21, of the wire which continues from the third arm 12 into a fourth arm 32 that continues a fourth distance in the second direction and into a fourth re-entrant loop 42. A four re-entrant loop 42, closely bent along loop 41, of the wire which continues into a fifth arm 13 of the wire a fifth distance in the first direction. A fifth re-entrant loop 23, spaced from loop 22, continues from the fifth arm 13 into a sixth arm 33 of the wire a sixth distance in the second direction. A sixth re-entrant loop 43, closely bent along loop 42, of the wire continues from the sixth arm 33 and into a seventh arm 14 of the wire a seventh distance but in the first direction. A seventh re-entrant loop 24, spaced from loop 23, of the wire continues from the seventh arm 14 into an eighth arm 34 of the wire. The eighth arm 34 terminates in rounded end B of the wire, an eighth distance in the second direction, all nesting in a common plane.

FIG. 2 is a side view of FIG. 1.

FIG. 3 is a configuration variation of FIG. 1 having five re-entrant loops and six arms with the discontinuous arm 33 terminating at end B.

FIG. 4 is a side view of FIG. 3.

FIG. 5 is a configuration variation of FIG. 1 having four re-entrant loops and four arms with the discontinuous loop 42 terminating at end B.

FIG. 6 is a side view of FIG. 5.

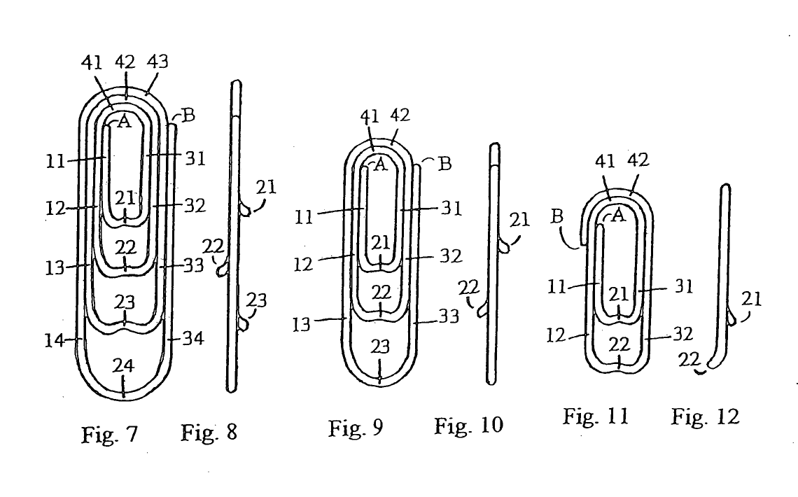

FIG. 7 is a configuration variation of FIG. 1 which loops 21, 22 and 23 are slightly bent outward into wave-like curve, alternately in opposite directions, so as to open the clamping jaws for the easy insertion of sheets of paper in between the jaws.

FIG. 8 is a side view of FIG. 7 showing loops 21, 22 and 23 are slightly bent outward alternately in opposite directions.

FIG. 9 is a configuration variation of FIG. 3 which loops 21 and 22 are slightly bent outward into wave-like curve, alternately in opposite directions, so as to open the clamping jaws for the easy insertion of sheets of paper in between the jaws.

FIG. 10 is a side view of FIG. 9 showing loop 21 and loop 22 are slightly bent outward in opposite directions.

FIG. 11 is a configuration variation of FIG. 5 which loops 21 and 22 are slightly bent outward into wave-like curve, alternately in opposite directions, so as to open the clamping jaws for the easy insertion of sheets of paper in between the jaws.

FIG. 12 is a side view of FIG. 11 showing loops 21 and 22 are slightly bent outward in opposite directions.

While a particular embodiment of the invention has been shown and described, and other modifications and variations have been discussed, it will be obvious that changes and further modifications, such as a in U-shaped, V-shaped, triangular or oblong configuration, may be made without departing from the invention in its broader aspects. It is the aim in the appended claims to cover all such changes and modifications as fall within the true spirit and scope of that which is patentable.

What is claimed is:

1. A paper clip manufactured in accordance with the present invention is composed of a single, continuous length of resilient metal wire multiply bent re-entrantly to define additional number of loops, including an upper portion and a lower portion and clamping arms, formed to comprise;
a) a first arm of the wire continuing in a first direction from one end of the wire, said a first distance;
b) a first re-entrant loop of the wire continuing from that first arm into a second arm, said a second distance in a second direction opposite the first direction;
c) a second re-entrant loop of the wire continuing from the second arm and into a third arm, said a third distance but in the first direction;
d) a third re-entrant loop of the wire, spaced from the first re-enter loop, continuing from the third arm into a fourth arm, said a fourth distance in the second direction;
e) a fourth re-entrant loop of the wire, closely bent along the second re-entrant loop, continuing from the fourth arm into a fifth arm, said a fifth distance in the first direction;
f) a fifth re-entrant loop of the wire, spaced from the third re-enter loop, continuing from the fifth arm into a sixth arm, said a sixth distance in the second direction;
g) a sixth re-entrant loop of the wire, closely bent along the fourth re-entrant loop, continuing from the sixth arm and into a seventh arm, said a seventh distance but in the first direction;
h) a seventh re-entrant loop of the wire, spaced from the fifth re-enter loop, continuing from the seventh arm into an eighth arm, said an eighth distance in the second direction;
i) the eighth arm then discontinuing in the other end of the wire;
j) all laying flat and nesting in a common plane; and
k) various number of re-entrant loops or convolutions could be included.

2. A paper clip as defined in claim 1 wherein upper portion comprising additional number of re-entrant loops are closely grouped together, each loop needs not be spaced from its adjacent loops, shortening the length of the clamping arms.

3. A paper clip as defined in claim 1 wherein lower portion comprising additional number of re-entrant loops interconnecting the length-reduced clamping arms as described in claim 2 form additional number of cooperating clamping jaws.
